(19) United States
(12) Patent Application Publication
(10) Pub. No.: US 2025/0190242 A1
(43) Pub. Date: Jun. 12, 2025

(54) Apparatus and Methods for Generating A Process and Data Management Machine

(71) Applicant: NetImpact Strategies, Inc., Falls Church, VA (US)

(72) Inventor: Praveen Kosgi, Aldie, VA (US)

(73) Assignee: NetImpact Strategies, Inc., Falls Church, VA (US)

(21) Appl. No.: 18/614,568

(22) Filed: Mar. 22, 2024

Related U.S. Application Data
(63) Continuation of application No. PCT/US2024/021001, filed on Mar. 21, 2024.
(60) Provisional application No. 63/607,548, filed on Dec. 7, 2023.

(51) Int. Cl. G06F 9/48

(52) U.S. Cl. CPC G06F 9/4843

(57) ABSTRACT

Provided are methods and apparatus for generating at least a portion of a process management machine. In an example, a computer-implemented method includes (i) receiving, by at least one processor and from a user interface device, information describing a selection of a case manager meta model (CMMM) including information describing a case type, an artifact type, an analysis objective, a resolution template, and at least two constituent processes; (ii) receiving, by the at least one processor and from the user interface device, information describing a selection of a process flow model, where the process flow model includes a performance order of the at least two constituent processes in the CMMM; (iii) automatically rendering, by the at least one processor, the at least two constituent processes in the CMMM to create a case management system application; and (iv) storing the case management system application on a non-transitory computer-readable medium.

### CROSS-REFERENCE TO RELATED APPLICATIONS

The present non-provisional patent application is a continuation of International Application No. PCT/US2024/021001, filed on Mar. 21, 2024, which claims priority to and the benefits of U.S. Provisional Patent Application No. 63/607,548, filed on Dec. 7, 2023, the disclosures of which are hereby incorporated herein in their entireties by specific reference thereto.

### FIELD OF DISCLOSURE

This disclosure relates generally to the technical fields of electronics, computer-readable media, computer engineering, and more specifically, but not exclusively, to apparatus and methods for generating a process management machine, a data management machine, or both.

### BACKGROUND

There is presently market demand for computer-implemented case management tools that are customized to meet specific needs for specific cases. To meet these needs, producing conventional computer-implemented case management tools requires writing case-specific customized computer code, which in turn leads to excessive product development lifecycles and case delays. In some circumstances, preparing the case-specific customized computer code can take one year or longer to produce because the case-specific customized computer code is manually written. In some circumstances, the case-specific customized computer code cannot be written soon enough to meet case deadlines that are near-term to the start of preparing the case-specific customized computer code. Sometimes, delays associated with preparing and finishing the case-specific customized computer code are so great that the cases that the case-specific customized computer code are intended to enhance are canceled as a result of the delays. Conventional techniques also create excess fragmentation of the cases that the case-specific customized computer code is intended to enhance. Accordingly, there are previously unaddressed and long-felt industry needs for methods and apparatus that improve upon conventional methods and apparatus.

### SUMMARY

As is described in greater detail herein, the instant disclosure describes various systems and methods for generating a process management machine. In examples, the process management machine can include at least a portion of a case management system configured as a set of computer-executable instructions (e.g. software instructions), where the computer-executable instructions can be stored on a suitable non-transitory computer-readable data storage element, a suitable non-transitory computer-readable medium, or both.

In an example, provided is a computer-implemented method for automatically generating at least a portion of a process management machine. The method can be performed by a computing device comprising at least one processor. In examples, the method can include: (i) receiving, by the at least one processor and from a user interface device, information describing a selection of a case manager meta model (CMMM), where the case manager meta model can include information describing a case type, an artifact type, an analysis objective, a resolution template, and at least two constituent processes; (ii) receiving, by the at least one processor and from the user interface device, information describing a selection of a process flow model, where the process flow model can include a performance order of the at least two constituent processes in the case manager meta model; (iii) automatically rendering, by the at least one processor, the at least two constituent processes in the case manager meta model to create a case management system (CMS) application; and (iv) storing the case management system application on a non-transitory computer-readable medium.

In an example, the case manager meta model can include context information including respective inputs and outputs between the at least two constituent processes in the case manager meta model.

In an example, the method can further include receiving, by the at least one processor and from the user interface device, information describing a modification of at least one constituent process in the case manager meta model.

In an embodiment, at least one constituent process in the case manager meta model can include a data model that can be configured to self-render.

In an example, the at least two constituent processes can self-render during the automatically rendering the at least two constituent processes in the case manager meta model.

In some embodiments, the automatically rendering the at least two constituent processes in the case manager meta model can create a customized CMS user interface in the case management system application. In an example, the customized CMS user interface in the case management system application can be configured to depict a timeline including a status of the at least two constituent processes in the case manager meta model.

In examples, provided is a system configured to generate a process management machine. The system can include (i) an electronic processor configured to execute a set of computer-executable instructions and (ii) a memory communicatively coupled to the electronic processor and storing the set of computer-executable instructions. The set of computer-executable instructions can be configured to cause the electronic processor to perform at least a portion of a method described herein.

In an example, provided is a system configured to automatically generate a process management machine. The system can include: (i) an electronic processor configured to execute a set of computer-executable instructions; and (ii) a memory communicatively coupled to the electronic processor and storing the set of computer-executable instructions. The set of computer-executable instructions can be configured to cause the electronic processor to: (i) receive, from a user interface device, information describing a selection of a case manager meta model, where the case manager meta model can include information describing a case type, an artifact type, an analysis objective, a resolution template, and at least two constituent processes; (ii) receive, from the user interface device, information describing a selection of a process flow model, where the process flow model can include a performance order of the at least two constituent processes in the case manager meta model; (iii) automatically render the at least two constituent processes in the case manager meta model to create a case management system application; and (iv) store the case management system application on a non-transitory computer-readable medium.

In an example, the case manager meta model can include context information including respective inputs and outputs between the at least two constituent processes in the case manager meta model.

In an example, the memory can further store instructions configured to cause the processor to receive, from the user interface device, information describing a modification of at least one constituent process in the case manager meta model.

In an embodiment, at least one constituent process in the case manager meta model can include a data model that can be configured to self-render.

In an example, the at least two constituent processes can self-render during the automatically rendering the at least two constituent processes in the case manager meta model.

In an embodiment, the automatically rendering the at least two constituent processes in the case manager meta model can create a customized CMS user interface in the case management system application. In an example, the customized CMS user interface in the case management system application can be configured to depict a timeline including a status of the at least two constituent processes in the case manager meta model.

Embodiments of the disclosed systems and methods are directed to processes and techniques, including at least partially automated processes and at least partially automated techniques, to generate a process management machine. In some embodiments, the disclosed systems include computer architecture components that can provide interfaces, code snippets, data structures, and information relationships to enable generating a process management machine.

In an embodiment, the disclosure is directed to an apparatus configured to generate a process management machine.

The apparatus can include a non-transitory computer-readable medium storing a set of computer-executable instructions and an electronic processor or co-processors. When executed by the electronic processor or co-processors, the instructions cause the electronic processor or co-processors (or a device of which they are part) to perform a set of operations that implement an embodiment of the disclosed methods.

In an embodiment, the disclosure is directed to a non-transitory computer-readable medium storing a set of computer-executable instructions, where the set of instructions can be executed by an electronic processor or co-processors to cause the processor or co-processors (or a device of which they are part) to perform a set of operations that implement an embodiment of the disclosed methods.

In an example, provided is a non-transitory computer-readable medium, comprising processor-executable instructions stored thereon configured to cause a processor to: (i) receive, from a user interface device, information describing a selection of a case manager meta model, where the case manager meta model can include information describing a case type, an artifact type, an analysis objective, a resolution template, and at least two constituent processes; (ii) receive, from the user interface device, information describing a selection of a process flow model, where the process flow model can include a performance order of the at least two constituent processes in the case manager meta model; (iii) automatically render the at least two constituent processes in the case manager meta model to create a case management system application; and store the case management system application on a non-transitory computer-readable medium.

In an example, the case manager meta model can include context information including respective inputs and outputs between the at least two constituent processes in the case manager meta model.

In an example, the non-transitory computer-readable medium can further include processor-executable instructions stored thereon configured to cause the processor to receive, from the user interface device, information describing a modification of at least one constituent process in the case manager meta model.

In an example, at least one constituent process in the case manager meta model can include a data model that can be configured to self-render.

In an example, the at least two constituent processes can self-render during the automatically rendering the at least two constituent processes in the case manager meta model.

In an example, the automatically rendering the at least two constituent processes in the case manager meta model can create a customized CMS user interface in the case management system application. In an embodiment, the customized CMS user interface in the case management system application can be configured to depict a timeline including a status of the at least two constituent processes in the case manager meta model.

In some embodiments, the systems and methods disclosed herein can provide services through a software as a service (SaaS), a multi-tenant platform, or a combination thereof. The multi-tenant platform can provide access to multiple entities (e.g. tenants), each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods or functions disclosed herein.

The terms “invention,” “the invention,” “this invention,” “the present invention,” “the present disclosure,” or “the disclosure” as used herein are intended to refer broadly to all subject matter disclosed in this document, the drawings (i.e. the Figures), and the claims. Statements containing these terms do not limit the subject matter disclosed or the meaning or scope of the claims. Embodiments covered by this disclosure are defined by the claims and not by this summary. This summary is a high-level overview of various examples and aspects of the disclosure and introduces some concepts that are further described in detail hereby. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Advantages of the provided systems, apparatuses, and methods will be apparent to one of ordinary skill in the art upon review of the detailed description and the included Figures. While the exemplary embodiments provided hereby are susceptible to various modifications and alternative forms, specific embodiments are shown by way of example in the drawings and are described in detail herein. However, the exemplary or specific embodiments are not intended to be limited to the forms described. Rather, the disclosure covers all modifications, equivalents, and alternatives falling within the scope of the appended claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

Embodiments of the disclosure are described with reference to the drawings, in which:

FIG. 1 depicts an example block diagram of an example method for generating a process management machine, in accordance with an embodiment of the disclosure.

FIG. 2A depicts an example network implementation of a system suitable for implementing examples of the disclosed subject matter.

FIG. 2B depicts an example diagram of an example computing device suitable for implementing examples of the disclosed subject matter.

FIG. 3 is a diagram depicting example case manager meta model inputs, in accordance with an embodiment of the disclosure.

FIG. 4 is a diagram depicting example steps for configuring a Case Management System, in accordance with an embodiment of the disclosure.

FIG. 5 is a diagram depicting example process flow case manager meta models that automatically trigger based on case manager meta model data, as well as base models that self-configure based on case manager meta model data, in accordance with an embodiment of the disclosure.

FIG. 6 is a diagram depicting an example automatically generated case management system, in accordance with an embodiment of the disclosure.

FIG. 7 is a diagram depicting example user interface information describing case manager meta models and characteristics of case manager meta models, in accordance with an embodiment of the disclosure.

FIG. 8 is a diagram depicting example CMS user interface information describing a status of an example case, in accordance with an embodiment of the disclosure.

FIG. 9 is a diagram depicting example user interface information describing types of case information, in accordance with an embodiment of the disclosure.

FIG. 10 is a diagram depicting example user interface information describing types of artifacts, in accordance with an embodiment of the disclosure.

FIG. 11 is a diagram depicting example user interface information describing example objects, in accordance with an embodiment of the disclosure.

FIG. 12 is a diagram depicting example user interface information describing application objects, in accordance with an embodiment of the disclosure.

FIG. 13 is a diagram depicting example user interface information describing cloud flow objects, in accordance with an embodiment of the disclosure.

FIG. 14 is a diagram depicting example user interface information describing process objects, in accordance with an embodiment of the disclosure.

FIG. 15 is a diagram depicting example user interface information describing table objects, in accordance with an embodiment of the disclosure.

FIG. 16 is a diagram depicting example user interface information describing an example case flow, in accordance with an embodiment of the disclosure.

FIG. 17 is a diagram depicting example CMS user interface information describing an executive dashboard, in accordance with an embodiment of the disclosure.

FIG. 18A is a diagram depicting example CMS user interface information describing a portion of a user dashboard, in accordance with an embodiment of the disclosure.

FIG. 18B is a diagram depicting example CMS user interface information describing a portion of a user dashboard, in accordance with an embodiment of the disclosure.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are example methods and apparatuses that can be used to perform automated process configuration and information storage. In some examples the provided methods and apparatuses can automatically generate a process management machine, a data management machine, or both.

In an example, provided is an application engine that can automatically create, from a preconfigured case manager meta model (CMMM), a user interface (UI) and data analysis processes for a case management system (CMS) application. In some examples, case manager meta models define constructs that the drive overall case processing and case lifecycle process. The case manager meta models can provide standardized software components that can work across multiple types of case management systems and enable producing an application engine from the standardized components. In examples, the case manager meta models are templates that can include predefined logical data entities and related relationships between the logical data entities. In some examples, case manager meta models can provide 80% (or more) of common aspects of case management in a precoded form, including associated objects. As used herein, the terms “meta model” and “metamodel” describe the same thing.

The application engine can advantageously automatically create user interface screens, process flows, and data models to support lookups and notifications automatically. The process management machine is configured to provide a case management system. The process management machine can be produced quickly and without having to write a large quantity of customized computer processor instructions. In an example, the process management machine can include an electronic processor communicatively coupled to an information storage device (e.g. a memory device), where the information storage device stores the CMS application and the electronic processor can be configured to execute at least a portion of the CMS application.

In some examples, the provided techniques can be used to advantageously configure a process management machine having a customized workflow process.

In some examples, the provided techniques can advantageously produce at least a portion of a process management machine without having to write original code for the implementation and without requiring a very long (e.g. greater than four weeks) development lifecycle.

In some embodiments, the disclosed systems can advantageously efficiently and quickly generate a process management machine, when compared to conventional techniques.

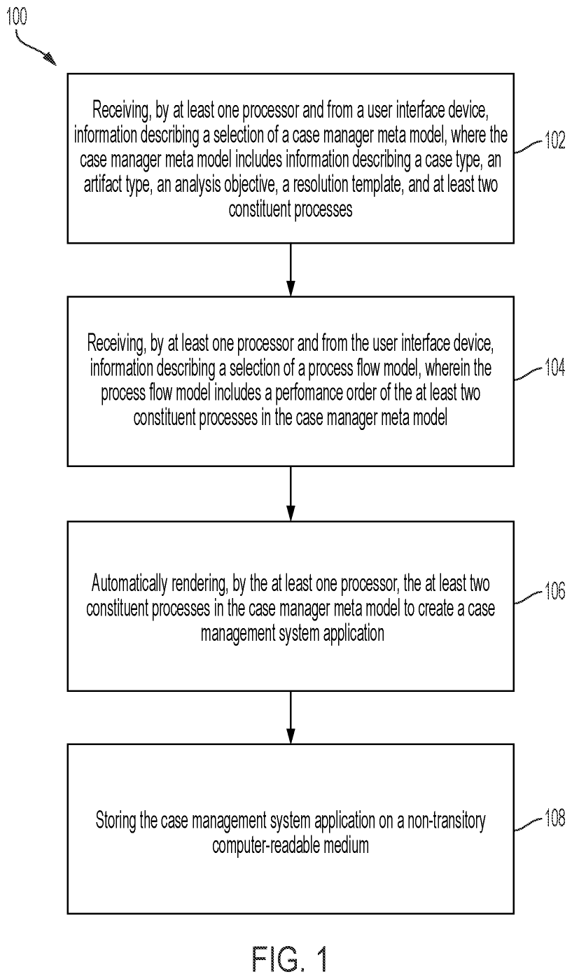

FIG. 1 depicts an example block diagram of an example method 100 that can be used to implement generating a process management machine, in accordance with an embodiment of the disclosure. In an embodiment, the method 100 can be implemented in a form of a set of computer-executable instructions. In examples, computer-executable instructions can include routines, programs, objects, components, data structures, procedures, operations, modules, functions, or a combination thereof, as non-limiting examples. Such computer-executable instructions can be executed by one or more programmed processors or co-processors.

The order in which the method 100 is described is not intended to be construed as a limitation, and any number of the described features can be combined in any order to implement the method 100 or alternate methods for automatically generating at least a portion of a process management machine. Additionally, individual features can be omitted, as is practicable, from the method 100 without departing from the scope of the subject matter described herein. Furthermore, the method 100 can be implemented in any suitable hardware, software, firmware, or a combination thereof, such as the apparatus described hereby.

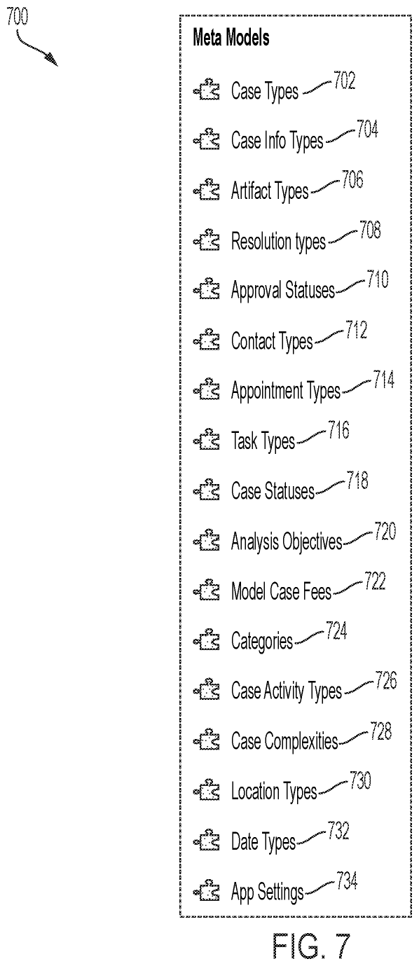

As shown in FIG. 1, at step 102, one or more of the devices described herein can receive, by at least one processor and from a user interface device, information describing a selection of a case manager meta model, where the case manager meta model can include information describing a case type, an artifact type, an analysis objective, a resolution template, at least two constituent processes, or combination of. The case manager meta model can include other information described herein. In an example, the case manager meta model can include at least one characteristic of case manager meta models 700 described in FIG. 7.

In an example, the case manager meta model can include context information including respective inputs and outputs between the at least two constituent processes in the case manager meta model.

In an example, the method can further include receiving, by the at least one processor and from the user interface device, information describing a modification of at least one constituent process in the case manager meta model.

In an embodiment, at least one constituent process in the case manager meta model can include a data model that can be configured to self-render.

In examples, the case manager meta model can include at least a portion of the information described in FIGS. 7 and 9-16, and in the descriptions thereof.

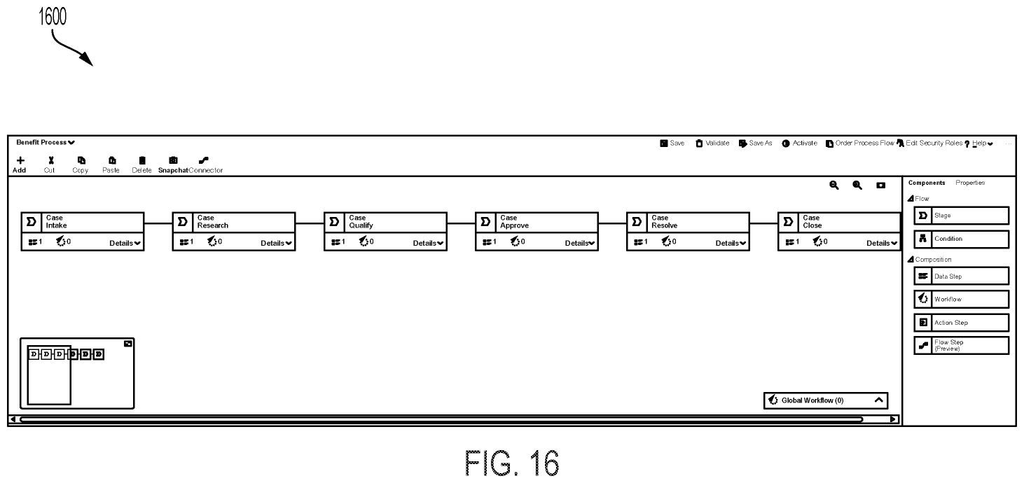

As shown in FIG. 1, at step 104, one or more of the devices described herein can receive, by the at least one processor and from the user interface device, information describing a selection of a process flow model, wherein the process flow model includes a performance order of at least two constituent processes in the case manager meta model. In an example, case flow 1600 in FIG. 16 describes a performance order of at least two constituent processes in a case manager meta model.

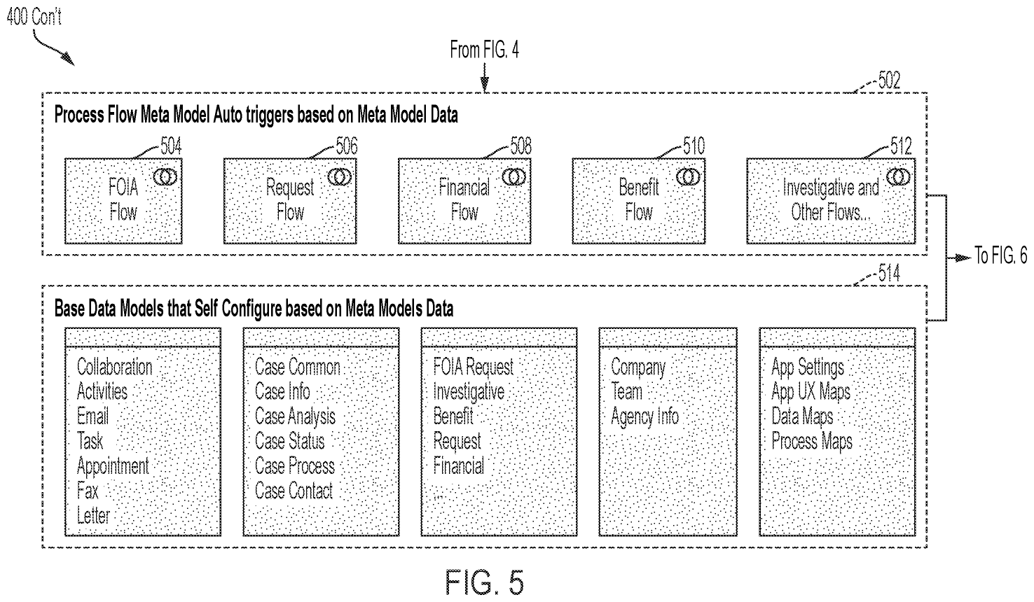

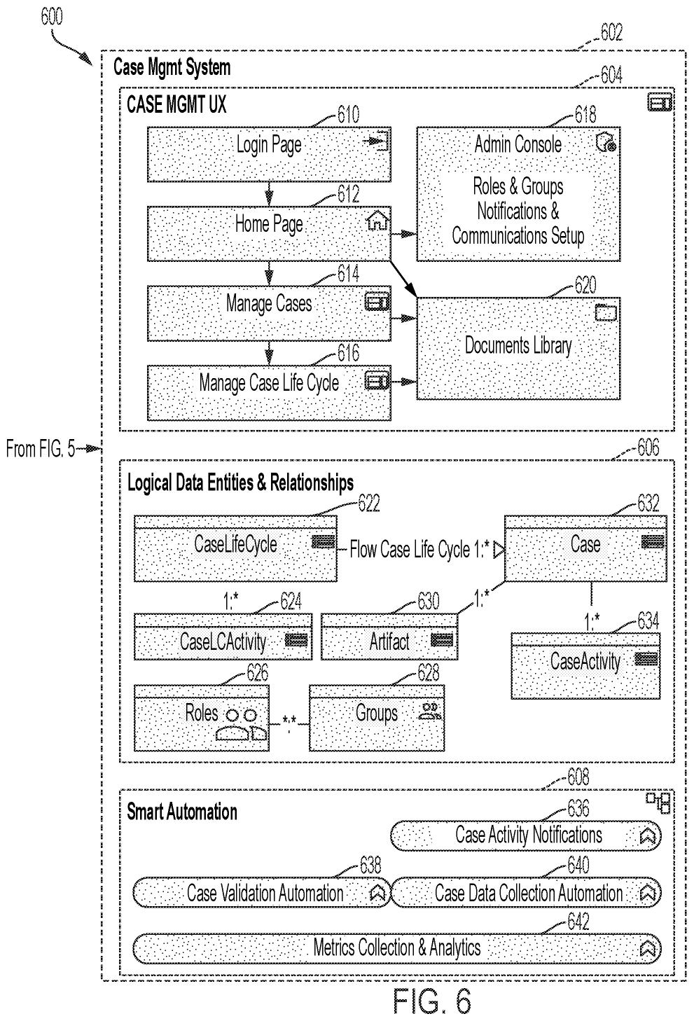

As shown in FIG. 1, at step 106, one or more of the devices described herein can automatically render, by the at least one processor, the at least two constituent processes in the case manager meta model to create a case management system application (e.g. automatically generated case management system 602 in FIG. 6). Process flow models that automatically trigger based on case manager meta model data 502 and base models 514 in FIG. 5 are examples of meta-model features that can automatically self-render.

In an example, the at least two constituent processes can self-render during the automatically rendering the at least two constituent processes in the case manager meta model.

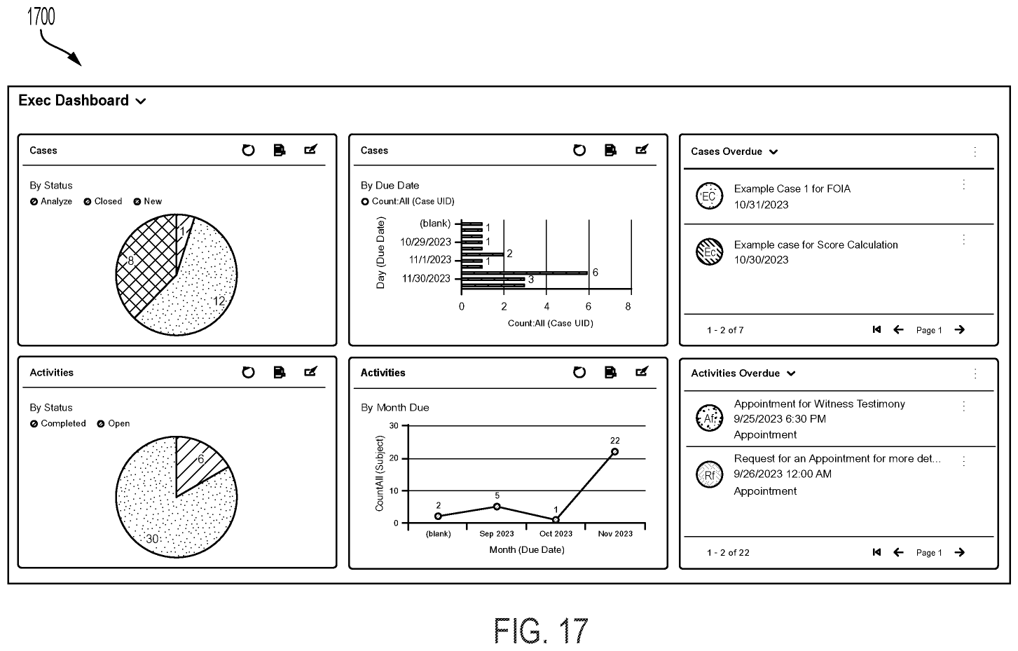

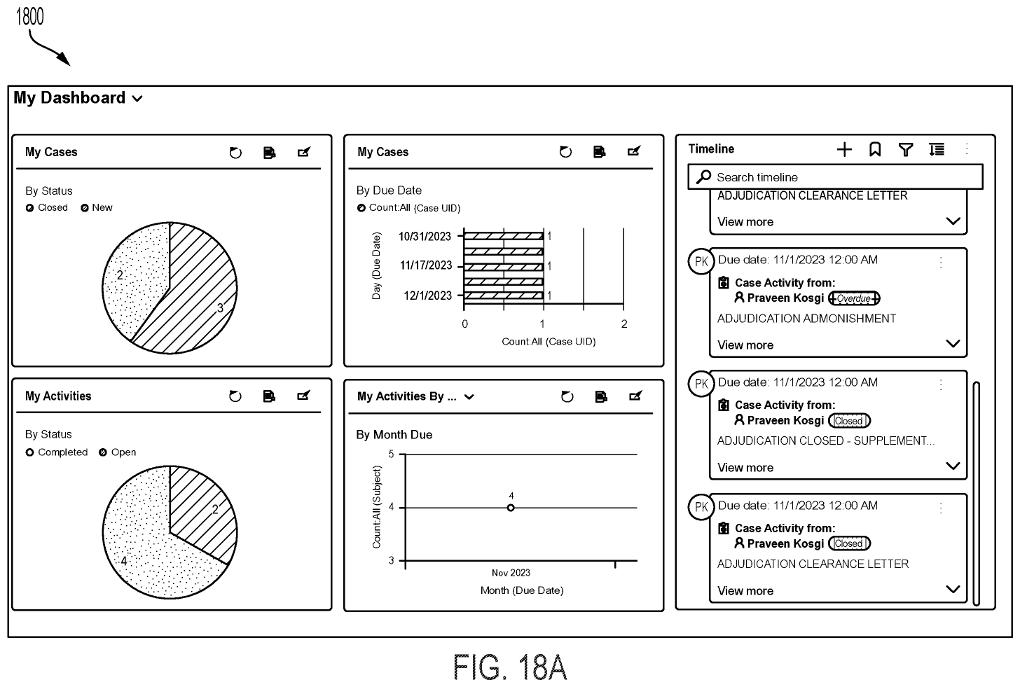

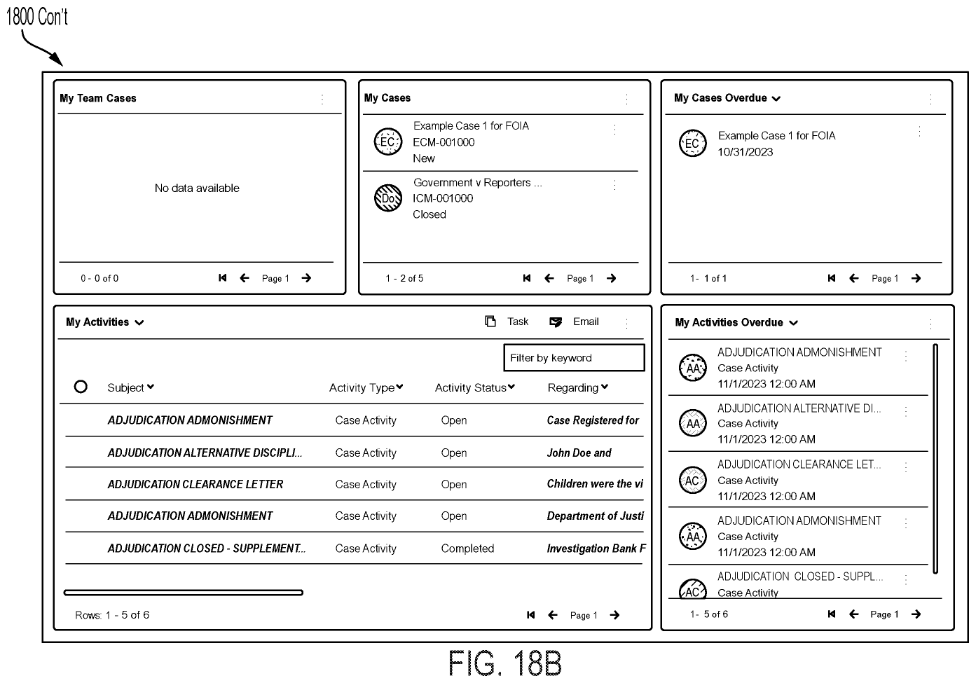

In some embodiments, the automatically rendering the at least two constituent processes in the case manager meta model can create a customized CMS user interface in the case management system application. In an example, the customized CMS user interface in the case management system application can be configured to depict a timeline including a status of the at least two constituent processes in the case manager meta model. An example, the customized CMS user interface can be customized per the information received in steps 102, 104, or a combination thereof. The non-limiting examples of CMS user interfaces are provided herein in FIGS. 17, 18A, and 18B, and in the descriptions thereof.

As shown in FIG. 1, at step 108, one or more of the devices described herein can store the case management system application on a non-transitory computer-readable medium. In an example, the non-transitory computer-readable medium can be coupled to an electronic processor that is configured to execute at least a portion of the CMS application stored on the non-transitory computer-readable medium. In an example, the electronic processor executes at least a portion of the CMS application stored on the non-transitory computer-readable medium.

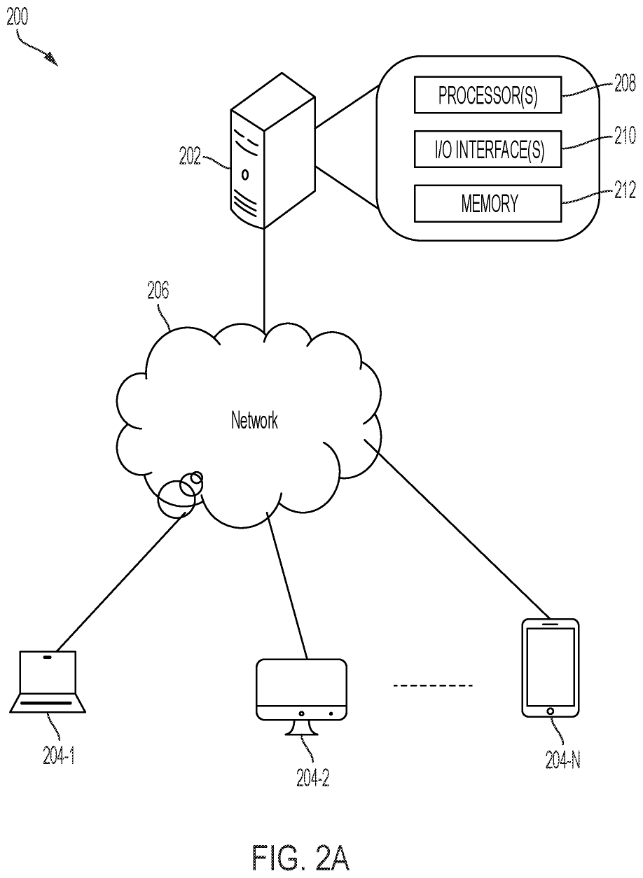

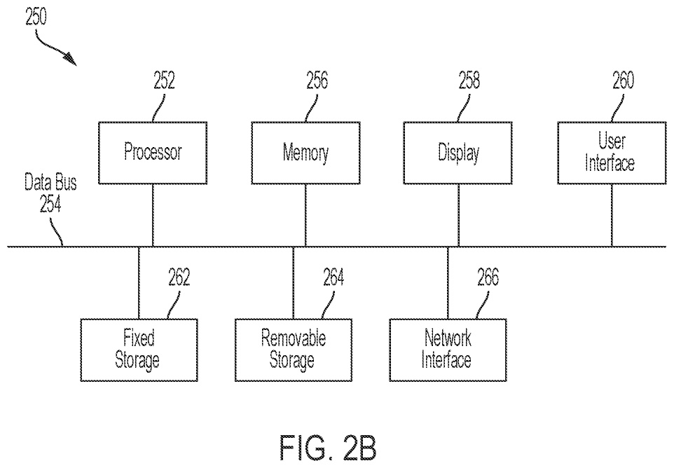

FIG. 2A depicts a network implementation 200 of a system 202. One or more users can access the system 202 through one or more user devices 204-1, 204-2 . . . 204-N, collectively referred to as user devices 204, hereinafter, or applications residing on the user devices 204.

Although the disclosure is explained considering that the system 202 is implemented on a server, the system 202 can be implemented in other forms of a computing device or system, such as a laptop computer, a desktop computer, a notebook, a workstation, a virtual environment, a mainframe computer, a server, a network server, or a cloud-based computing environment. It will be understood that the system 202 can be accessed by multiple users through one or more user devices 204-1, 204-2 . . . 204-N.

In one implementation, the system 202 can comprise a cloud-based computing environment in which the user can operate individual computing systems configured to execute remotely located applications. Examples of the user devices 204 can include, but are not limited to, a portable computer, a personal digital assistant, a handheld device, a workstation, or a combination thereof. The user devices 204 can be communicatively coupled to the system 202 through a network 206.

In one implementation, the network 206 can be a wireless network, a wired network, or a combination thereof. The network 206 can be implemented as one of several different types of networks, including but not limited to an intranet, local area network (LAN), wide area network (WAN), the Internet, or a combination thereof. The network 206 can be a dedicated network or a shared network. A shared network can be an association of different types of networks that use a variety of protocols, for example, Hypertext Transfer Protocol (HTTP), Transmission Control Protocol/Internet Protocol (TCP/IP), or Wireless Application Protocol (WAP) to communicate with one another. Further, the network 206 can include a variety of network devices, including routers, bridges, servers, computing devices, storage devices, or a combination thereof.

In an embodiment, system 202 can include at least one processor 208, an input/output (I/O) interface 210, and a memory 212. The processor 208 can be implemented as one or more microprocessors, microcomputers, microcontrollers, digital signal processors, Central Processing Units (CPUs), state machines, logic circuitries, devices that manipulate signals based on operational instructions, or a combination thereof. Among other capabilities, the at least one processor 208 can be configured to fetch and execute computer-readable instructions stored in the memory 212.

The in/out (I/O) interface 210 can include software and hardware interfaces, for example, a web interface, a graphical user interface (GUI, UI), and the like. The I/O interface 210 can allow the system 202 to interact with the user directly or through at least one of the client devices 204-1 to 204-N. Further, the I/O interface 210 can enable the system 202 to communicate with other computing devices, such as web servers and external data servers (not shown). The I/O interface 210 can facilitate communications and data transfer within a wide variety of networks and protocol types, including wired networks (for example, Local Area Network or cable) and wireless networks (such as wireless local area network, a cellular network, or a satellite network). The I/O interface 210 can include one or more ports for connecting a number of devices to one another or to another server.

The memory 212 can include a computer-readable medium or computer program product. Non-limiting examples include volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 212 can include routines, programs, objects, instructions, modules, components, or data structures which perform particular tasks or implement particular abstract data types. The memory 212 can include programs or instructions that supplement applications and functions of the system 202. In an embodiment, the memory 212 can serve as a repository for storing data processed, received, generated or a combination thereof by one or more programs or coded instructions.

FIG. 2B depicts an example diagram of an example computing device 250 suitable for implementing examples of the disclosed subject matter. For example, at least a portion of the computing device 250 can be suitable for use as a component part of the system 202, at least one of the user devices 204-1 to 204-N, or a combination thereof. In another example, at least a portion of the computing device 250 can be coupled to the network 206.

In examples, aspects of the computing device 250 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 2B is an illustrative example and is not limiting.

In some examples, the computing device 250 can include a processor 252, a data bus 254, a memory 256, a display 258, a user interface 260, a fixed storage device 262, a removable storage device 264, a network interface 266, the like, or a combination thereof. These elements are described in further detail herein.

The processor 252 can be a hardware-implemented processing unit configured to control at least a portion of operation of the computing device 250. The processor 252 can perform logical and arithmetic operations based on processor-executable instructions stored within the memory 256. The processor 252 can be configured to execute instructions that cause the processor 252 to initiate at least a part of a method described hereby. In an example, the processor 252 can interpret instructions stored in the memory 256 to initiate at least a part of a method described hereby. In an example, the processor 252 can execute instructions stored in the memory 256 to initiate at least a part of a method described hereby. The instructions, when executed by the processor 252, can transform the processor 252 into a special-purpose processor that causes the processor to perform limited functions including at least a part of a function described hereby. The processor 252 can also be referred to as a central processing unit (CPU), a special-purpose processor (e.g. a non-generic processor), or both.

In some examples, the computing device 250 can implement machine-learning techniques (e.g. using a Convolutional Neural Network (CNN), etc.) to collect information, process information, or both. In some examples, information stored in an information storage device of the computing device 250 can be transferred to another computing device.

The processor 252 can comprise or be a component of a physical processing system implemented with one or more processors. In some examples, the processor 252 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a suitable physical device configured to manipulate information (e.g., calculating, logical operations, the like, or a combination thereof), the like, or a combination thereof.

The data bus 254 can couple components of the computing device 250. The data bus 254 can enable information communication between the processor 252 and one or more components coupled to the processor 252. In some examples, the data bus 254 can include a data bus, a power bus, a control signal bus, a status signal bus, the like, or a combination thereof. In an example, the components of the computing device 250 can be communicatively coupled together to communicate with each other using a different suitable mechanism.

The memory 256 generally represents any type or form of volatile storage device, non-volatile storage device, medium, the like, or a combination thereof. The memory 256 can store data (e.g. a database), processor-readable instructions, the like, or a combination thereof. In an example, the memory 256 can store data, load data, maintain data, or a combination thereof. In an example, the memory 256 can store processor-readable instructions, load processor-readable instructions, maintain processor-readable instructions, or a combination thereof. In some embodiments, the memory 256 can store computer-readable instructions configured to cause a processor (e.g. the processor 252) to initiate performing at least a portion of a method described hereby. The memory 256 can be a main memory configured to store an operating system, an application program, the like, or a combination thereof. The memory 256 can store a basic input-output system (BIOS) which can control basic hardware operation such as interaction of the processor 252 with peripheral components. The memory 256 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 256 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, a database, the like, or a combination thereof) and is configured to provide the information to the processor 252.

The display 258 can include a component configured to visually convey information to a user of the computing device 250. In examples, the display 258 can be a video display screen, such as a light-emitting diode (LED) screen, a touch screen, or both.

The user interface 260 can include user devices such as a switch, a keypad, a keyboard, a touch screen, a microphone, a speaker, an audio production device, a jack for coupling the computing device to an audio production device, the like, or a combination thereof. The user interface 260 can optionally include a user interface controller. The user interface 260 can include a component configured to convey information to a user of the computing device 250, a component configured to receive information from the user of the computing device 250, or both.

The fixed storage device 262 can include one or more hard drive, flash storage device, the like, or a combination thereof. The fixed storage device 262 can be an information storage device (e.g. storing a database) that is not configured to be removed during use. The fixed storage device 262 can optionally include a fixed storage device controller. The fixed storage device 262 can be integral with the computing device 250 or can be separate and accessed through an interface.

The removable storage device 264 can be integrated with the computing device 250 or can be separated and accessed through other interfaces. The removable storage device 264 can be an information storage device (e.g. storing a database) that is configured to be removed during use, such as a memory card, a jump drive, a flash storage device, an optical disk, the like, or a combination thereof. The removable storage device 264 can optionally include a removable storage device controller. The removable storage device 264 can be integrated with the computing device 250 or can be separate and accessed through an interface.

In examples, a computer-readable storage medium such as one or more of the memory 256, the fixed storage device 262, the removable storage device 264, a remote storage location, the like, or a combination thereof can store non-transitory computer-executable instructions configured to cause a processor (e.g. the processor 252) to implement at least an aspect of the present disclosure.

The network interface 266 can couple the processor 252 (e.g. via the data bus 254) to a network and enable exchanging information between the processor 252 and the network. In some examples, the network interface 266 can couple the processor 252 (e.g. via the data bus 254) to the network and enable exchanging information between the processor 252 and another computing device. For example, the network interface 266 can enable the processor 252 to communicate with one or more other network devices. The network interface 266 can couple to the network using any suitable technique and any suitable protocol. In some examples, the network interface 266 can include a data bus, a power bus, a control signal bus, a status signal bus, the like, or a combination thereof. Example techniques and protocols the network interface 266 can be configured to implement include digital cellular telephone, WiFi™, Bluetooth®, near-field communications (NFC), the like, or a combination thereof.

The network can couple the processor 252 to one or more other network devices. In some examples, the network can enable exchange of information between the processor 252 and the one or more other network devices. In some examples, the network can enable exchange of information between the processor 252 and another computing device. The network can include one or more private networks, local networks, wide-area networks, the Internet, other communication networks, the like, or a combination thereof. In some examples, the network can be a wired network, a wireless network, an optical network, the like, or a combination thereof.

In some embodiments, the network device can store computer-readable instructions configured to cause a processor (e.g. the processor 252) to initiate performing at least a portion of a method described hereby. In an example, the one or more other network devices can store non-transitory computer-executable instructions configured to cause a processor (e.g. the processor 252) to implement at least an aspect of the present disclosure. The non-transitory computer-executable instructions can be received by the processor 252 and implemented using at least a portion of techniques described hereby. In another example, information described hereby can be stored in the fixed storage device 262, the removable storage device 264, the network device, the like, or a combination thereof.

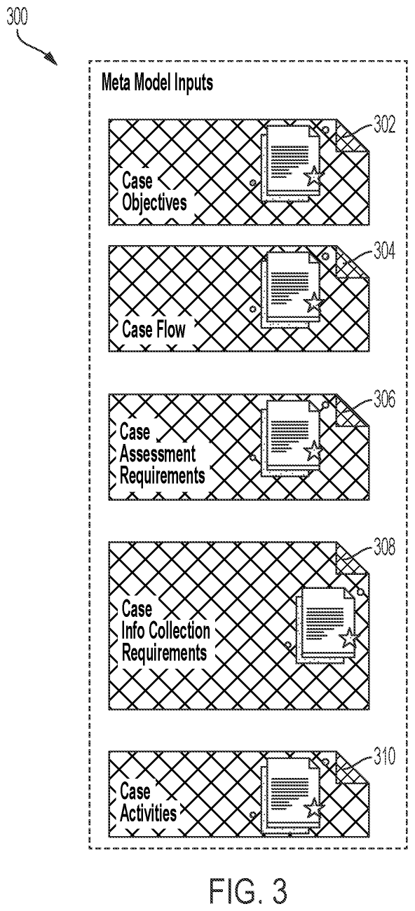

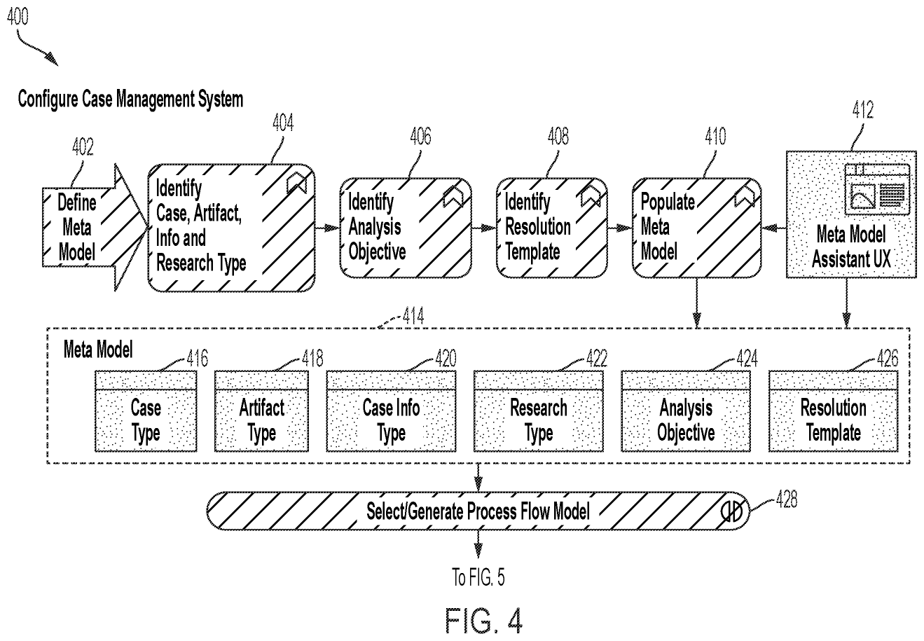

FIG. 3 is a diagram depicting example case manager meta model inputs 300, in accordance with an embodiment of the disclosure. The case manager meta model inputs 300 describe information that can be used to determine how a case manager meta model is configured. The case manager meta model inputs 300 depicted in FIG. 3 are not limiting. In examples, information described by at least one of the case manager meta model inputs 300 can be a constituent part of a case manager meta model (e.g. case manager meta model 414 in FIG. 4).

A case objectives meta model input 302 can include information that describes at least one goal of a case.

A case flow meta model input 304 can include information that describes at least a portion of a process for achieving at least one goal of a case. The case flow meta model input 304 can include constituent processes to be performed to achieve at least one of the goals of the case. The constituent processes can include a required process, an optional process, or both. The constituent processes can be arranged relative to each other in a serial manner, a parallel manner, or a combination thereof.

A case assessment requirements meta model input 306 can include information describing at least a portion of a required process for evaluating a status of a case.

A case information collection requirements meta model input 308 can include information describing at least a portion of required information that must be collected as at least a portion of the process for achieving at least one of the goals of the case. In examples, the required information must be collected and can be analyzed as at least a portion of a process for achieving at least one of the goals in the case.

A case activities meta model input 310 can include information describing at least a portion of a constituent process to be performed to achieve at least one of the goals of the case.

FIG. 4 is a diagram depicting example steps for configuring a Case Management System 400, in accordance with an embodiment of the disclosure. The steps for configuring the Case Management System 400 depicted in FIG. 4, example process flow meta models that automatically trigger based on case manager meta model data 502 in FIG. 5, and base data models that self-configure based on case manager meta model data 514 in FIG. 5 can automatically generate a case management system and thus can automatically generate a process management machine. The example steps for configuring a Case Management System 400 can be configured as a set of computer-executable instructions (e.g. software instructions), where the computer-executable instructions can be stored by a non-transitory computer-readable data storage device, a non-transitory computer-readable medium, or both.

In optional step 402 in FIG. 4, a case manager meta model 414, can be defined. The defining can include performing steps 404, 406, and 408. Step 402 can include requesting user input information (e.g. via a user interface) to select at least one constituent portion of the case manager meta model 414, to label at least one constituent portion of the case manager meta model 414, or both. Step 402 can also include receiving user input information (e.g. via the user interface) identifying at least one constituent portion of the case manager meta model 414, labeling at least one constituent portion of the case manager meta model 414, or both. The received user information can be stored in the case manager meta model 414.

Step 404 can include requesting user input information (e.g. via the user interface) to identify a case type, to identify artifact information, and to identify the type of research to be included in the case management system. Step 404 can also include receiving user input information (e.g. via the user interface) identifying the case type to be included in the case management system, identifying artifact information to be included in the case management system, identifying the type of research to be included in the case management system, or a combination thereof. The received user information can be stored in the case manager meta model 414.

Step 406 can include requesting user input information (e.g. via the user interface) to identify analysis objectives of the case management system. Step 406 can also include receiving user input information (e.g. via the user interface) identifying at least one analysis objective of the case management system. The received user information can be stored in the case manager meta model 414.

Step 408 can include requesting user input information (e.g. via the user interface) to identify a resolution template of the case management system. Step 408 can also include receiving user input information (e.g. via the user interface) selecting the resolution template of the case management system from a plurality of resolution templates. The received user information can be stored in the case manager meta model 414.

In step 410 in FIG. 4, the case manager meta model 414 defined in step 402 can be populated with the user information received in steps 404, 406, and 408.

In optional step 412 in FIG. 4, a case manager meta model configuration assistant user interface can be configured as the user interface by which a user can receive information, input information, or both to configure the case manager meta model 414, and thus a Case Management System generated from the case manager meta model.

In an example, the case manager meta model configuration assistant user interface can present at least two preconfigured case manager meta models via the user interface and receive user input indicating a selection of one of the preconfigured case manager meta models. The case manager meta model configuration assistant user interface can accept user input indicating a modification to the selected preconfigured case manager meta model by performing at least one of steps 404, 406, or 408 and modifying the selected preconfigured case manager meta model with the received user information.

The case manager meta model 414 can include information describing a case type 416, an artifact type 418, a case information type 420, a research type 422, an analysis objective 424, a resolution template 426, or a combination thereof. In examples, the information in the case manager meta model 414 can be configured to generate a CMS application that is configured to enable user to manage a process (e.g. an investigation, manufacturing a device, supplying a device, etc.). Example processes are provided in the example process flow meta models 502 in FIG. 5.

Step 428 can include requesting user input information (e.g. via the user interface) to select a preconfigured process flow for the case management system or to generate a process flow for the case management system. Step 428 can also include receiving user input information (e.g. via the user interface) selecting the preconfigured process flow for the case management system or generating the process flow for the case management system. The process flow for the case management system can be based at least in part upon the case flow meta model input 304. Examples of process flow meta models are depicted in FIG. 5. The process flow meta model can include information in the case manager meta model 414 that is arranged in an order to be performed as part of the case management system to achieve the at least one of the goals of the case. The constituent processes of the process flow meta model can include the information describing the case type 416, the artifact type 418, the case information type 420, the research type 422, the analysis objective 424, a resolution template 426, or a combination thereof. The constituent processes can be arranged relative to each other in a serial manner, a parallel manner, or a combination thereof.

The steps for configuring the Case Management System 400 can include a step in which the case management system 602 in FIG. 6 is automatically generated from the process flow meta model. The automatic generation of the case management system 602 can include self-rendering by constituent portions of at least one case manager meta model to create the case management system 602 and thus generate the process management machine. In examples, the process management machine can include at least a portion of the case management system 602 configured as a set of computer-executable instructions (e.g. software instructions), where the computer-executable instructions can be stored on a non-transitory computer-readable data storage device, a non-transitory computer-readable medium, or both.

FIG. 5 is a diagram depicting the example process flow meta models that automatically trigger based on case manager meta model data 502, as well as the base data models 514 that self-configure based on case manager meta model data, in accordance with an embodiment of the disclosure.

Non-limiting examples of process flow meta models that can automatically trigger based on case manager meta model data 502 to automatically generate the case management system 602 are depicted in FIG. 5.

FIG. 5 depicts an example Freedom of Information Act (FOIA) process flow 504 that can be configured to achieve at least one goal of a FOIA case.

Further, an example request process flow 506 can be configured to achieve at least one goal of a request case.

An example financial process flow 508 can be configured to achieve at least one goal of a financial case.

An example benefit process flow 510 can be configured to achieve at least one goal of a benefit case.

An example investigative process flow 512 can be configured to achieve at least one goal of an investigation case.

FIG. 5 also depicts base data models 514 that self-configure based on case manager meta model data. The base data models 514 are examples of constituent portions of a case manager meta model relating to categories of case-specific information that can be received, analyzed, communicated, or otherwise processed by the case management system 602 during performance of a process in a case.

FIG. 6 is a diagram 600 depicting an example automatically generated case management system 602, in accordance with an embodiment of the disclosure. The case management system 602 can include a case management system user interface 604, logical data entities and relationships between the logical data entities 606, and a smart automation component 608.

The case management user interface 604 can include user interface functionality including, and not limited to, a login page 610, homepage 612, a user interface for case management 614, a user interface for managing a lifecycle of a case 616, an administrative console 618, a documents library 620 (e.g. for storing information relating to data models, artifacts, or a combination thereof), or a combination thereof.

The logical data entities and relationships between the logical data entities 606 can include information describing a case lifecycle 622, case activities 624, user roles 626 user groups 628 an artifact 630, the case 632, case activity 634, or a combination thereof.

The smart automation component 608 can include case activity notifications 636, case validation automation 638, case data collection automation 640, case metric collection and analytics 642, or a combination thereof.

FIG. 7 is a diagram depicting example user interface information describing case manager meta models and characteristics of case manager meta models 700, in accordance with an embodiment of the disclosure. In a nonlimiting example, the user interface information describing case manager meta models and characteristics of case manager meta models 700 can describe a least a portion of constituent information in the case manager meta model 414.

In an example, Case Types 702 can provide configurability for different kinds of cases within an application.

In an example, Case Info Types 704 can provide information that can be collected for a case.

In an example, Artifact Types 706 can provide types of artifacts that can be documented based on a case type.

In an example, Resolution Types 708 can be templated documents (e.g. including text) that can be auto-populated based on a type of resolution selected for a case.

In an example, Approval Status 710 can be a case manager meta model that can be used to configure types of approvals required for a specific case type.

In an example, Contact Types 712 can provide a type of contacts that can be relevant for a case to be documented and can be used for communicating information describing at least a portion of a case lifecycle process.

In an example, Appointment Types 714 can provide an ability to configure various appointment types for cases.

In an example, Task Types 716 can provide a type of tasks that can be used to track activity for a case.

In an example, Case Status 718 can provide a detailed case status configuration based on a case type.

In an example, Analysis Objectives 720 can provide baseline analysis requirements for a case type including, for example, a type of analysis description and example outcomes that may be expected.

In an example, Model Case Fees 722 can provide an ability to define and track a type of fees that performing a case can incur.

In an example, Categories 724 can provide an ability to track categories of activities within a case lifecycle process, tasks within a case lifecycle process, cases within a case lifecycle process, documents within a case lifecycle process, other objects within a case lifecycle process, or a combination thereof. In an example, the Categories 724 can provide an ability to tag categories of activities within a case lifecycle process, tasks within a case lifecycle process, cases within a case lifecycle process, documents within a case lifecycle process, other objects within a case lifecycle process, or a combination thereof.

In an example, Case Activity Types 726 can provide an ability to configure a specific type of activities that are relevant to a case type. The Case Activity Types 726 can be customized based on the type of case, as well as a type of activity that is a part of the case lifecycle process.

In an example, Case Complexities 728 can be a lookup list that can be customized. In an example, the Case Complexities 728 can be used, based on a case type, to track a complexity of a case.

In an example, Location Types 730 can provide an ability to organize location information that, for example, can be used across multiple case steps.

In an example, a Date Types 732 case manager meta model characteristic can provide an ability to track at least one type of dates that are relevant to the case. In nonlimiting examples, the Date Types 732 case manager meta model characteristic can be used to track investigation milestones, to provide guidance (e.g. via a user interface) relating to tasks necessary to accomplish investigation milestones, or a combination thereof.

In an example, App Settings 734 can provide key-value pair settings that can be configured across an application for user interface (UI) automation, user experience (UX) automation, lifecycle process activities automation, or a combination thereof.

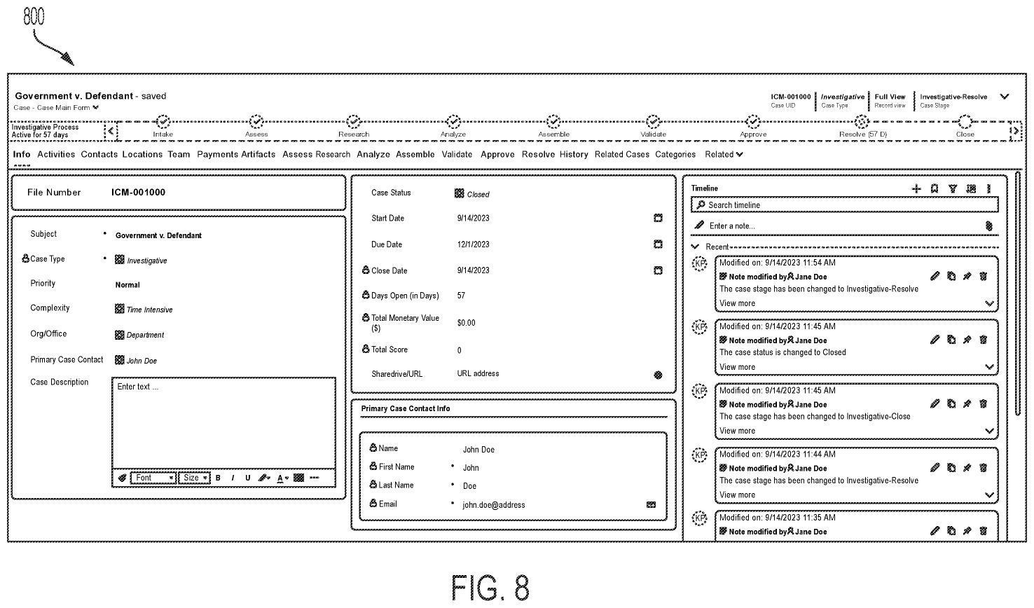

FIG. 8 is a diagram depicting example CMS user interface information describing a status of an example case 800, in accordance with an embodiment of the disclosure.

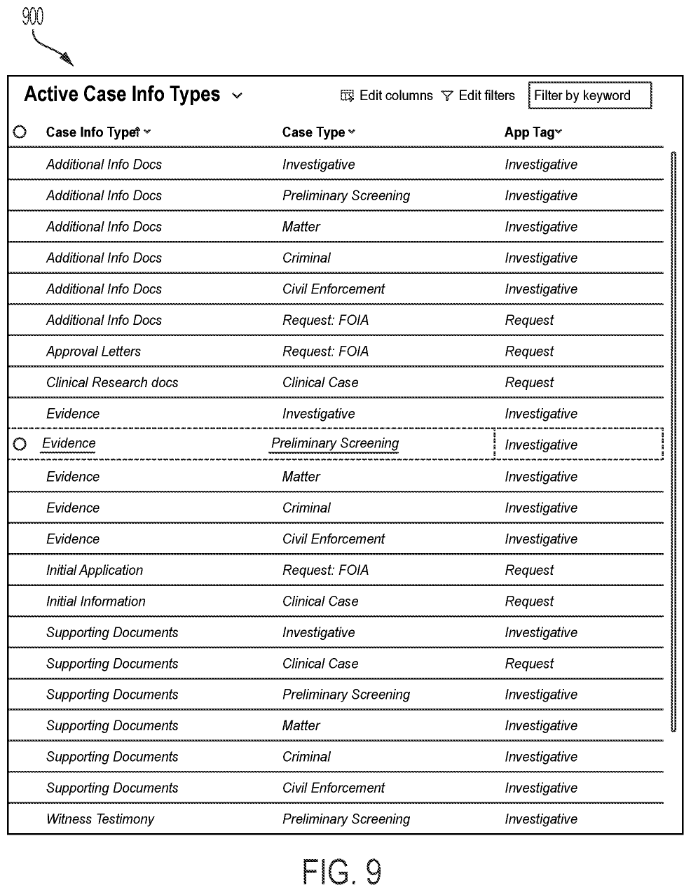

FIG. 9 is a diagram depicting example user interface information describing types of case information 900 in an example case manager meta model, in accordance with an embodiment of the disclosure.

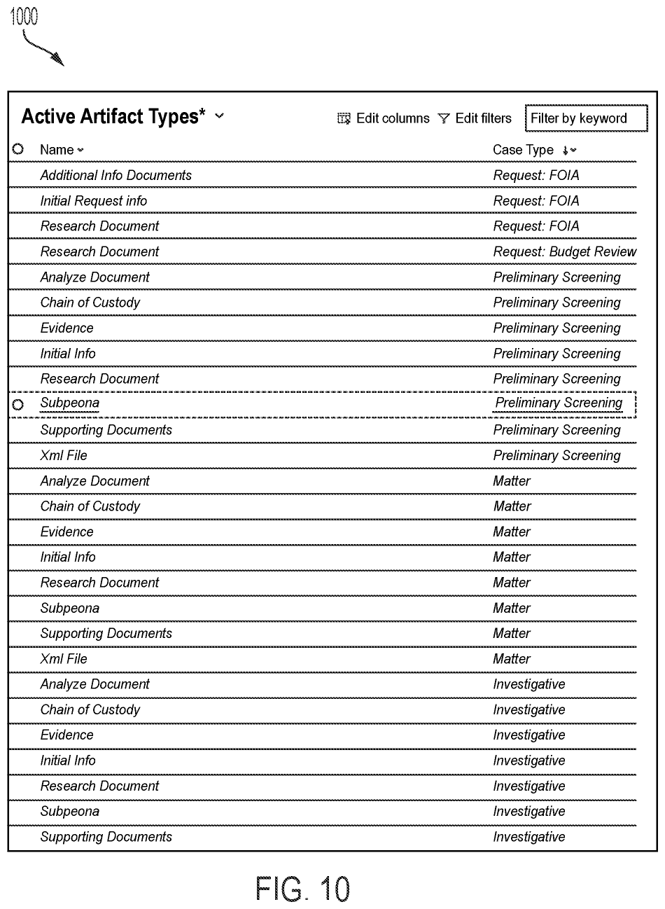

FIG. 10 is a diagram depicting example user interface information describing types of artifacts 1000 in an example case manager meta model, in accordance with an embodiment of the disclosure.

In an example, artifact types can be configured based on case types that provide document organization for case information document management. Following the configuring of artifact types, document templates can be available to generate branded case report information based on a specific implementation.

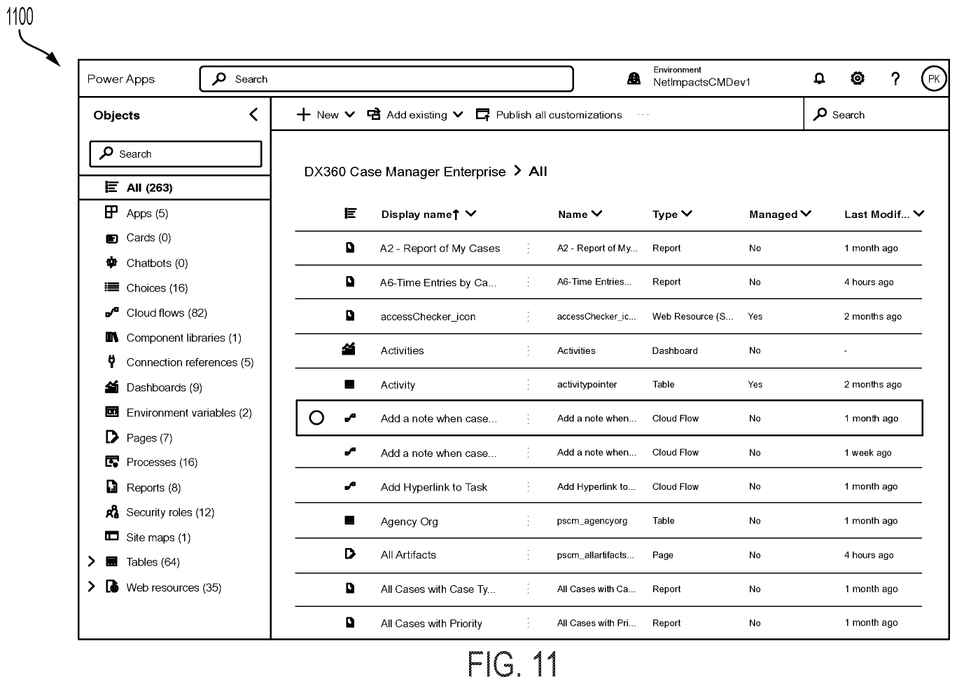

FIG. 11 is a diagram depicting example user interface information describing example objects 1100 in an example case manager meta model, in accordance with an embodiment of the disclosure. In an example, application components (e.g. objects) can automatically self-render to customize a CMS UI. The customization can be based on a case type, a stage within a case process, business rules, or a combination thereof.

In an example, case manager meta models can provide conditional and context information for the application code to render the objects based on the case type, a case process, artifact types, activity types, or combinations thereof. Prior to self-rendering, the objects that self-render can collect the conditional and context information from the case manager meta models and then automatically customize a user interface of the generated CMS application (e.g. using an Application User Interface Configuration Tag (APPUI), an Application Business Process Configuration Tag (APPBP), or both).

In an example, case manager meta model information can be used to relate and establish a context (e.g. including respective standardized inputs and outputs between smart objects) for the application component rendering process along with application code written to interpret the context.

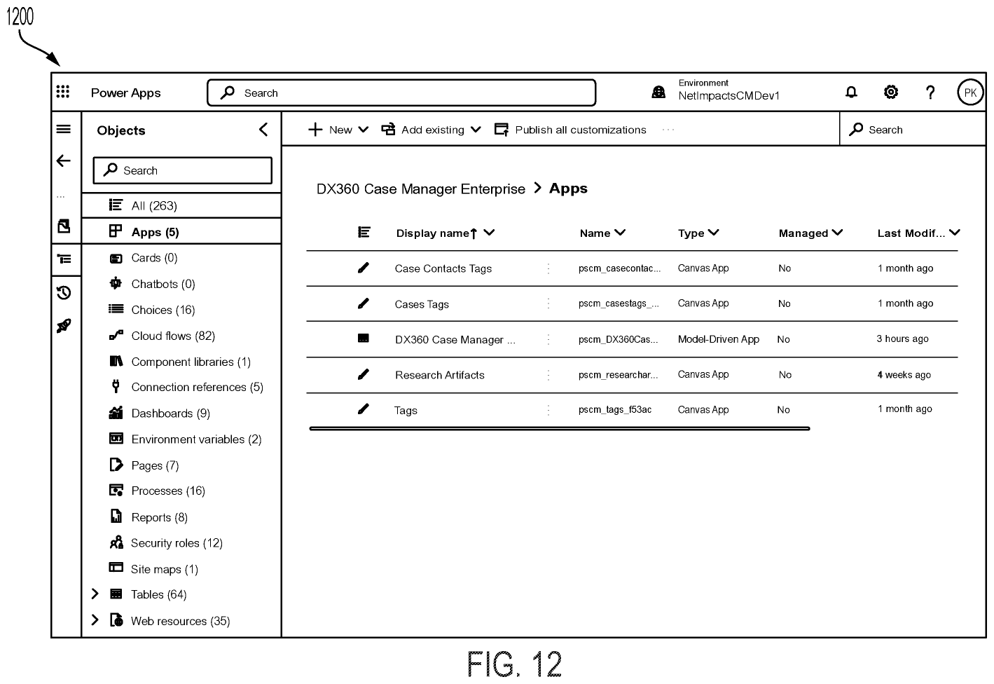

FIG. 12 is a diagram depicting example user interface information describing application objects 1200 in an example case manager meta model, in accordance with an embodiment of the disclosure.

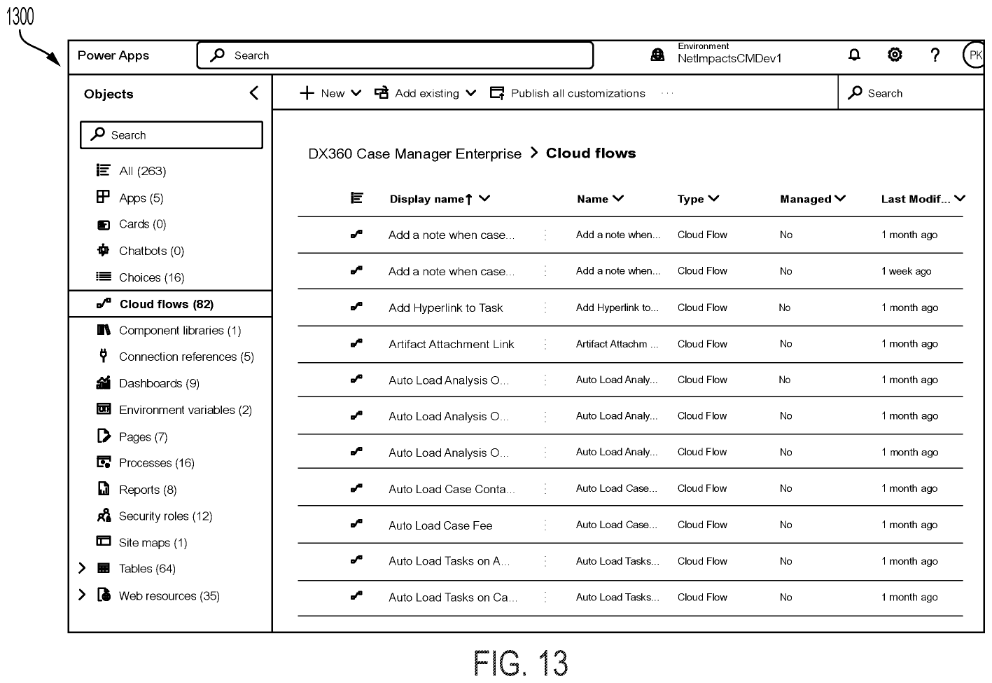

FIG. 13 is a diagram depicting example user interface information describing cloud flow objects 1300 in an example case manager meta model, in accordance with an embodiment of the disclosure.

In examples, cloud flow objects can include automated processes such as calculations, process stages, activities, notifications, records processing, or a combination thereof. A presence of a cloud flow object can be based on life cycle stages, business rules, or a combination thereof.

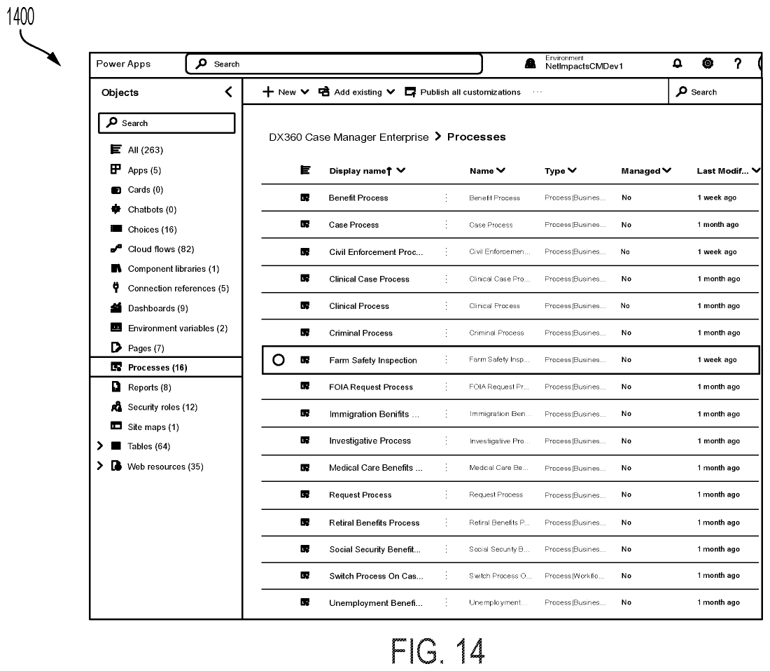

FIG. 14 is a diagram depicting example user interface information describing process objects 1400 in an example case manager meta model, in accordance with an embodiment of the disclosure.

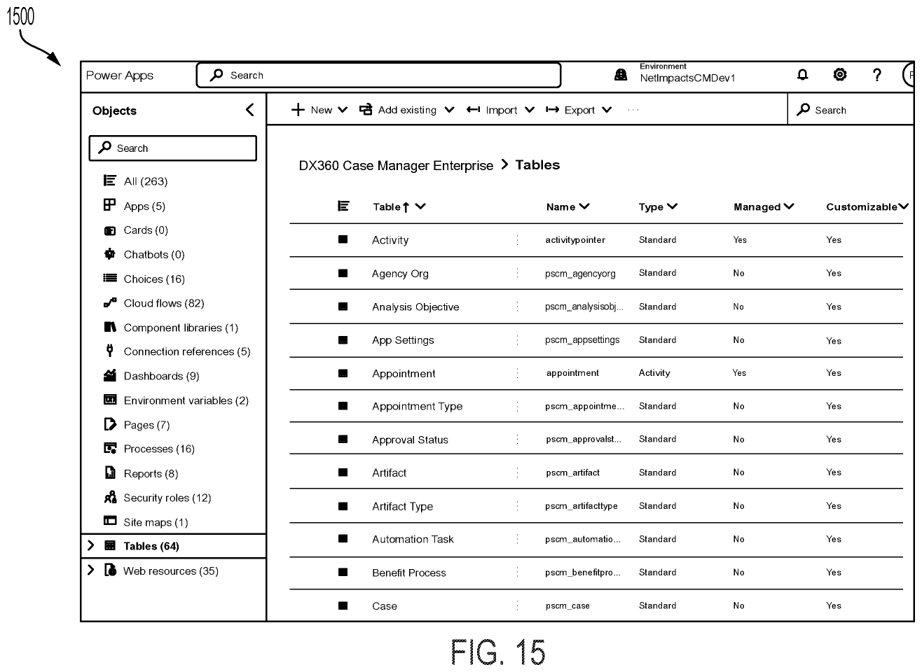

FIG. 15 is a diagram depicting example user interface information describing table objects 1500 in an example case manager meta model, in accordance with an embodiment of the disclosure.

FIG. 16 is a diagram depicting example user interface information describing an example case flow 1600 of constituent parts of a case manager meta model, in accordance with an embodiment of the disclosure.

FIG. 17 is a diagram depicting example CMS user interface information describing an executive dashboard 1700, in accordance with an embodiment of the disclosure. The executive dashboard 1700 is an example of the CMS UI 604.

FIG. 18A is a diagram depicting example CMS user interface information describing a portion of a user dashboard 1800, in accordance with an embodiment of the disclosure. The user dashboard 1800 is an example of the CMS UI 604.

FIG. 18B is a diagram depicting example CMS user interface information describing a portion of a user dashboard 1850, in accordance with an embodiment of the disclosure. The user dashboard 1850 is an example of the CMS UI 604.

Exemplary embodiments discussed herein can provide certain advantages. These advantages can include those provided by the disclosed features.

Although systems and methods for generating a process management machine are described hereby in a language specific to structural features and/or methods, the appended claims are not necessarily limited to the specific features or methods described. Rather, the specific features and methods are disclosed as examples of implementations for generating a process management machine.

One or more embodiments of the disclosed subject matter are described herein with specificity to meet statutory requirements, but this description does not limit the scope of the claims. The claimed subject matter can be embodied in other ways, can include different elements or steps, and can be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure can be practiced. The disclosure may, however, be embodied in different forms and should not be construed as limited to the embodiments set forth herein, rather, these embodiments are provided so that this disclosure will satisfy the statutory requirements and convey the scope of the disclosure to those skilled in the art.

Among others, the subject matter of the disclosure can be embodied in whole or in part as a system, as one or more methods, or as one or more devices. Embodiments can take the form of a hardware implemented embodiment, a software implemented embodiment, or an embodiment combining software and hardware aspects. For example, in some embodiments, one or more of the operations, functions, processes, or methods disclosed and/or described herein can be implemented by one or more suitable processing elements (such as a processor, co-processor, microprocessor, Central Processing Unit, Graphics Processing Unit, Tensor Processing Unit, Quantum Processing Unit, controller, or a combination thereof, as non-limiting examples) that is part of a client device, server, network element, remote platform (such as a Software as a Service (SaaS) platform), an “in the cloud” service, or other form of computing or data processing system, device, or platform.

The processing element or elements can be programmed with a set of executable instructions (e.g. software instructions), where the instructions can be stored on (or in) one or more suitable non-transitory computer-readable data storage elements, one or more suitable non-transitory computer-readable media, or both. In an embodiment, the set of instructions can be conveyed to a user through a transfer of instructions or an application that executes a set of instructions (such as over a network, e.g., the Internet). In an embodiment, a set of instructions or an application can be utilized by an end-user through access to a SaaS platform or a service provided through such a platform.

In an embodiment, the systems and methods disclosed herein can provide services through a SaaS or multi-tenant platform. The platform provides access to multiple entities, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods, features, or functions disclosed herein.

In an embodiment, one or more of the operations, functions, processes, features, or methods disclosed herein can be implemented by a specialized form of hardware, such as a programmable gate array, application specific integrated circuit (ASIC), or the like. An embodiment of the disclosure can be implemented in the form of an application, a sub-routine that is part of a larger application, a “plug-in,” an extension to the functionality of a data processing system or platform, or other suitable form. This description is, therefore, not to be taken in a limiting sense.

It should be understood that the present invention as described herein can be implemented in a form of control logic using computer software in a modular or integrated manner. Based on the disclosure and teachings provided herein, a person of ordinary skill in the art will know and appreciate other techniques to implement an embodiment of the disclosure using hardware or a combination of hardware and software.

Any of the software components, processes or functions described in this application can be implemented as software code to be executed by a processor using any suitable computer language such as at least one of Python, Java, JavaScript, C, C++, C# (“C Sharp”), Type Script, Java Script, Platform Client Application Programming Interface (API) Script, or Perl using procedural, functional, object-oriented, or other techniques. The software code can be stored as a series of instructions, or commands in (or on) a non-transitory computer-readable medium, such as a random-access memory (RAM), a read only memory (ROM), a magnetic medium such as a hard-drive, a jump drive, an optical medium such as a CD-ROM, or a combination thereof. In this context, a non-transitory computer-readable medium is almost any medium suitable for the storage of data or an instruction set aside from a transitory waveform. Any such computer readable medium can reside on or within a single computational apparatus and can be present on or within different computational apparatuses within a system or network.

According to one example implementation, the term processing element or processor, as used herein, can be a central processing unit (CPU), or conceptualized as a CPU (such as a virtual machine). In this example implementation, the CPU or a device in which the CPU is incorporated can be at least one of coupled, connected, or in communication with one or more peripheral devices, such as the user display device. In another example implementation, the processing element or processor can be incorporated into a mobile computing device, such as a smartphone or tablet computer.

The non-transitory computer-readable storage medium referred to herein can include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium can include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. In some embodiments, one or more of the blocks, or stages or steps may not necessarily need to be performed in the order presented or may not necessarily need to be performed.

The computer-executable program instructions described herein can be loaded onto a special purpose computer, a processor, or other programmable data processing apparatus to produce a specific example of a machine, such that the instructions executed by the computer, processor, or other programmable data processing apparatus create means for implementing one or more of the functions, operations, processes, or methods described herein. These computer program instructions can also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims when they have structural elements, functional elements, or both that do not differ from the literal language of the claims, or if they include structural elements, functional elements, or both with insubstantial differences from the literal language of the claims.

The use of the terms “a,” “an,” “the,” and similar referents in the specification and in the following claims are to be construed to cover both the singular and the plural, unless otherwise indicated herein or clearly contradicted by context. The singular portends the plural, where practicable. The terms “having,” “including,” “containing,” and similar referents in the specification and in the claims are to be construed as open-ended terms (e.g. meaning “including, but not limited to,”) unless otherwise noted. All methods described herein can be performed in any suitable order unless otherwise indicated herein or clearly contradicted by context. The use of all examples, or exemplary language (e.g. “such as”) provided herein, is intended merely to better illuminate embodiments of the disclosure and do not pose a limitation to the scope of the invention unless otherwise claimed. No language in the specification should be construed as indicating any non-claimed element as essential to each embodiment of the present invention.

The words “receiving,” “generating,” “extracting,” “determining,” “calculating,” and other forms thereof are intended to be open ended in that an item or items following any one of these words is not meant to be an exhaustive listing of such item or items or meant to be limited to only the listed item or items. The term “or” is used inclusively to refer to items in the alternative and in combination.

Different arrangements of the components depicted in the drawings or described above, as well as components and steps not shown or described are possible. Similarly, some features and sub-combinations are useful and can be employed without reference to other features and sub-combinations. Embodiments of the invention have been described for illustrative and not restrictive purposes, and alternative embodiments will become apparent to readers of this patent. Accordingly, the present invention is not limited to the embodiments described herein or depicted in the drawings, and various embodiments and modifications can be made without departing from the scope of the claims. The disclosed embodiments are merely exemplary of the disclosure, which can be embodied in various forms.

What is claimed is:

1. A computer-implemented method for automatically generating at least a portion of a process management machine, the method being performed by a computing device comprising at least one processor, the method comprising:
receiving, by the at least one processor and from a user interface device, information describing a selection of a case manager meta model, wherein the case manager meta model includes information describing a case type, an artifact type, an analysis objective, a resolution template, and at least two constituent processes;
receiving, by the at least one processor and from the user interface device, information describing a selection of a process flow model, wherein the process flow model includes a performance order of the at least two constituent processes in the case manager meta model;
automatically rendering, by the at least one processor, the at least two constituent processes in the case manager meta model to create a case management system (CMS) application; and
storing the case management system application on a non-transitory computer-readable medium.

2. The computer-implemented method of claim 1, wherein the case manager meta model comprises context information including respective inputs and outputs between the at least two constituent processes in the case manager meta model.

3. The computer-implemented method of claim 1, further comprising, receiving, by the at least one processor and from the user interface device, information describing a modification of at least one constituent process in the case manager meta model.

4. The computer-implemented method of claim 1, wherein at least one constituent process in the case manager meta model includes a data model that is configured to self-render.

5. The computer-implemented method of claim 1, wherein the at least two constituent processes self-render during the automatically rendering the at least two constituent processes in the case manager meta model.

6. The computer-implemented method of claim 1, wherein the automatically rendering the at least two constituent processes in the case manager meta model creates a customized CMS user interface in the case management system application.

7. The computer-implemented method of claim 6, wherein the customized CMS user interface in the case management system application is configured to depict a timeline including a status of the at least two constituent processes in the case manager meta model.

8. A system configured to automatically generate a process management machine, comprising:
an electronic processor configured to execute a set of computer-executable instructions; and
a memory communicatively coupled to the electronic processor and storing the set of computer-executable instructions, wherein the set of computer-executable instructions are configured to cause the electronic processor to:
receive, from a user interface device, information describing a selection of a case manager meta model, wherein the case manager meta model includes information describing a case type, an artifact type, an analysis objective, a resolution template, and at least two constituent processes;
receive, from the user interface device, information describing a selection of a process flow model, wherein the process flow model includes a performance order of the at least two constituent processes in the case manager meta model;
automatically render the at least two constituent processes in the case manager meta model to create a case management system (CMS) application; and
store the case management system application on a non-transitory computer-readable medium.

9. The system of claim 8, wherein the case manager meta model comprises context information including respective inputs and outputs between the at least two constituent processes in the case manager meta model.

10. The system of claim 8, wherein the memory further stores instructions configured to cause the processor to receive, from the user interface device, information describing a modification of at least one constituent process in the case manager meta model.

11. The system of claim 8, wherein at least one constituent process in the case manager meta model includes a data model that is configured to self-render.

12. The system of claim 8, wherein the at least two constituent processes self-render during the automatically rendering the at least two constituent processes in the case manager meta model.

13. The system of claim 8, wherein the automatically rendering the at least two constituent processes in the case manager meta model creates a customized CMS user interface in the case management system application.

14. The system of claim 13, wherein the customized CMS user interface in the case management system application is configured to depict a timeline including a status of the at least two constituent processes in the case manager meta model.

15. A non-transitory computer-readable medium, comprising processor-executable instructions stored thereon configured to cause a processor to:
receive, from a user interface device, information describing a selection of a case manager meta model, wherein the case manager meta model includes information describing a case type, an artifact type, an analysis objective, a resolution template, and at least two constituent processes;
receive, from the user interface device, information describing a selection of a process flow model, wherein the process flow model includes a performance order of the at least two constituent processes in the case manager meta model;
automatically render the at least two constituent processes in the case manager meta model to create a case management system (CMS) application; and
store the case management system application on a non-transitory computer-readable medium.

16. The non-transitory computer-readable medium of claim 15, wherein the case manager meta model comprises context information including respective inputs and outputs between the at least two constituent processes in the case manager meta model.

17. The non-transitory computer-readable medium of claim 15, further comprising processor-executable instructions stored thereon configured to cause the processor to receive, from the user interface device, information describing a modification of at least one constituent process in the case manager meta model.

18. The non-transitory computer-readable medium of claim 15, wherein at least one constituent process in the case manager meta model includes a data model that is configured to self-render.

19. The non-transitory computer-readable medium of claim 15, wherein the at least two constituent processes self-render during the automatically rendering the at least two constituent processes in the case manager meta model.

20. The non-transitory computer-readable medium of claim 15, wherein the automatically rendering the at least two constituent processes in the case manager meta model creates a customized CMS user interface in the case management system application.

21. The non-transitory computer-readable medium of claim 20, wherein the customized CMS user interface in the case management system application is configured to depict a timeline including a status of the at least two constituent processes in the case manager meta model.
